(19) United States
(12) Patent Application Publication
(10) Pub. No.: US 2014/0025723 A1
(43) Pub. Date: Jan. 23, 2014

(54) CLOUD STORAGE SYSTEM AND DATA STORAGE AND SHARING METHOD BASED ON THE SYSTEM

(71) Applicants: ZHONG-LIN XU, Shenzhen City (CN); YAO-HUA LIU, Shenzhen City (CN); XIN LU, Shenzhen City (CN); SHIH-FANG WONG, Tu-Cheng (TW)

(72) Inventors: ZHONG-LIN XU, Shenzhen City (CN); YAO-HUA LIU, Shenzhen City (CN); XIN LU, Shenzhen City (CN); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/586,892

(22) Filed: Aug. 16, 2012

(30) Foreign Application Priority Data
Jul. 18, 2012 (CN) 201210248636.9

(51) Int. Cl. G06F 15/16

(52) U.S. Cl. 709/203

(57) ABSTRACT

A cloud storage system comprises at least one server, and an intermediate device that communicates with the at least one server and a plurality of client devices that are presented on a network. The client devices comprise various data for sharing, and attribute information of the sharing data are stored in the at least one server through the intermediate device. The intermediate device establishes peer to peer connections between the client devices, and controls data transmission between the client devices through the peer to peer connections, so that the client devices can share their data through the peer to peer connections.

### BACKGROUND

1. Technical Field

Embodiments of the present disclosure relate generally to cloud storage technologies, and particularly to a cloud storage system and a data storage and sharing method based on the system.

2. Description of Related Art

Cloud storage services are used for storing various types of data. In many cloud storage solutions, one or more servers may act as a data center for storing a large amount of data from various client devices. Since a large amount of data is for storing in the data center, servers with high performance and a large storage space are desired, which is costly. Further, when a number of client devices simultaneously access the data from the servers, the data transmission rate may be unacceptably low.

### BRIEF DESCRIPTION OF THE DRAWINGS

FIG. 1 illustrates one embodiment of a cloud storage system in communication with a plurality of client devices through a network.

FIG. 2 is a schematic diagram of an example of a web server group of FIG. 1.

FIG. 3 is a schematic block diagram of one embodiment of an intermediate device of the cloud storage system of FIG. 1.

FIG. 4 is a flowchart of one embodiment of a data storage and sharing method using the cloud storage system of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one”.

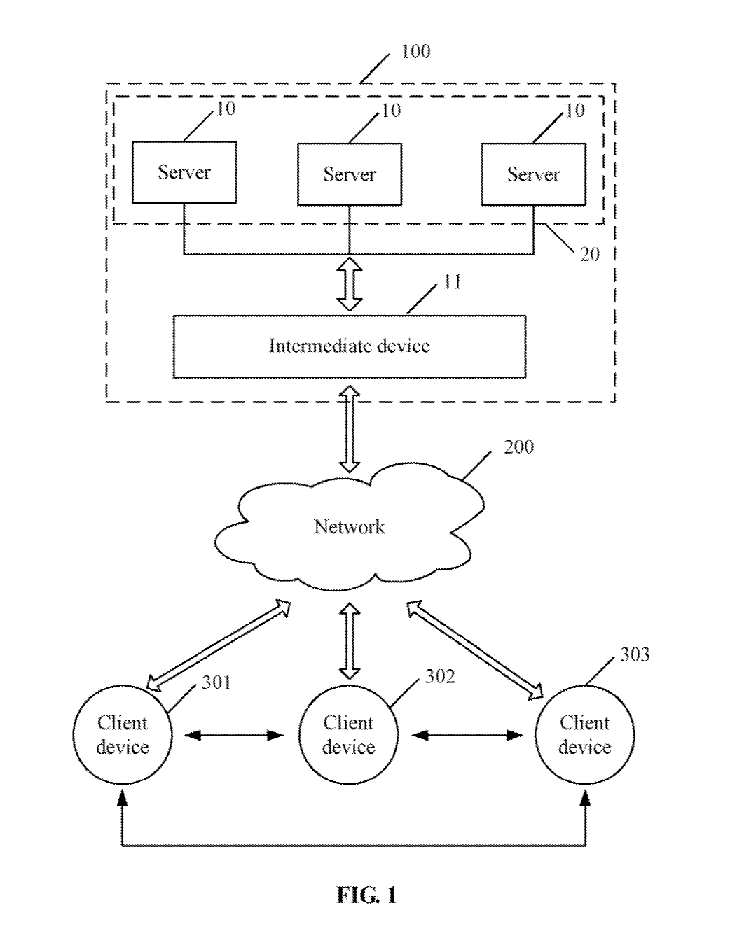

FIG. 1 illustrates one embodiment of a cloud storage system 100 in communication with a plurality of client devices through a network 200. In the embodiments, the cloud storage system 100 includes an intermediate device 11 and a web server group 20 that is composed of a plurality of servers 10. The intermediate device 11 communicates and exchanges data with each of the servers 10. The intermediate device 11 connects to the network 200, and communicates with client devices such as 301, 302, and 303 of FIG. 1 that are presented on the network 200. The network 200 may be a wired network or a wireless network.

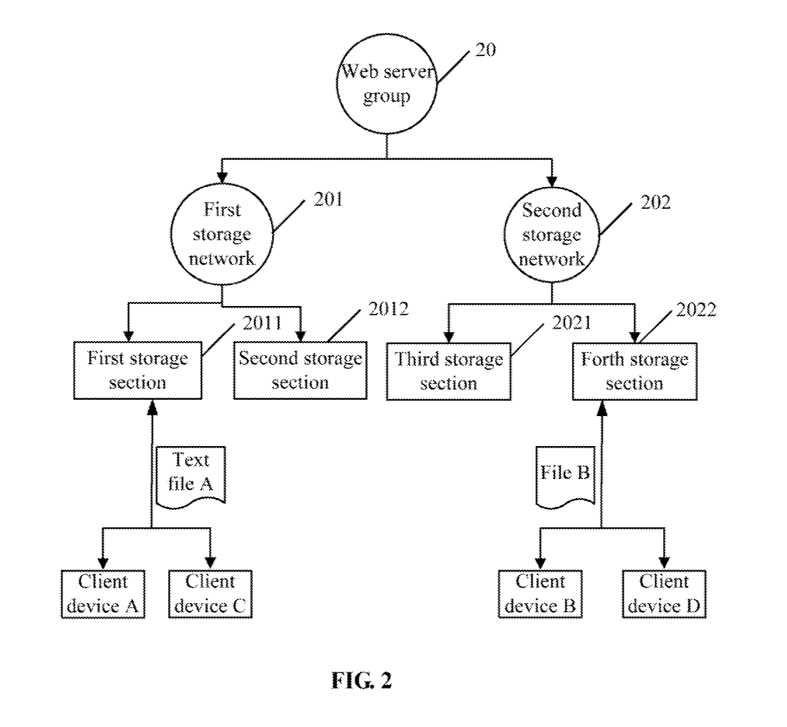

Referring to FIG. 2, the web server group 20 includes a first storage network 201 and a second storage network 202. The first storage network 201 includes a portion of the servers 10 of the web server group 20, and the second storage network 202 includes the remaining portion of the servers 10 of the web server group 20. In the embodiment, the first storage network 201 may be defined as a public network for storing data of public users. The second storage network 202 may be defined as a private network for storing private data, such as data of users of some particular companies.

Each of the first storage network 201 and the second storage network 202 may be divided into multiple storage sections. Each of the storage sections is configured for storing different types of data (e.g., text, photos, and videos). For example, the first storage network 201 includes a first storage section 2011 and a second storage section 2012. The second storage network 202 includes a third storage section 2021 and a forth storage section 2022. The first storage section 2011 and the third storage section 2021 may be configured for storing texts, while the second storage section 2012 and the forth storage section 2022 may be configured for storing photos and videos.

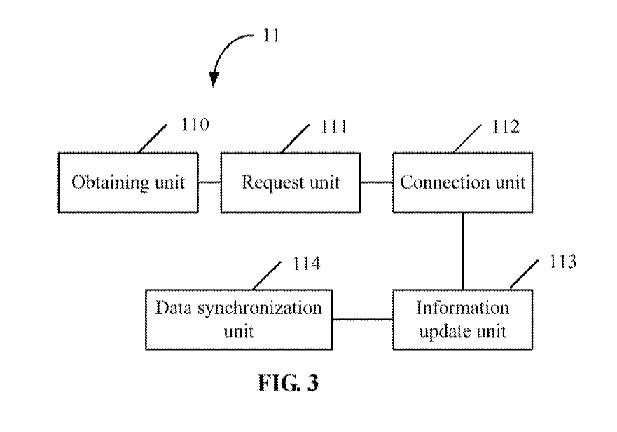

FIG. 3 is a schematic block diagram of one embodiment of the intermediate device 11 of FIG. 1. In the embodiment, the intermediate device 11 includes an obtaining unit 110, a request unit 111, a connection unit 112, an information update unit 113, and a data synchronization unit 114. The intermediate device 11 may be a computing device having functions of data transmission and processing, such as a computer. FIG. 3 shows only one example of the intermediate device 11, and intermediate device 11 can include more or fewer components such as storage devices and processors, or have a different configuration of the components.

The obtaining unit 110 obtains attribute information of reference data to be shared (hereinafter “sharing data”) that is provided by any of the client devices, and stores the obtained attribute information into the server 10 of the web server group 20. The sharing data refers to data stored in one or more of the client devices, and can be accessed/shared by any other client device through the network 200. The attribute information may include a data name, a data size, and a version of the sharing data, and location information indicating where the sharing data is stored, such as an IP address and/or a MAC address of one or more of client devices that contain the sharing data. In the embodiment, the obtaining unit 110 may store the attribute information of the sharing data in any server 10 of a storage section of the web server group 20 according to a type of the sharing data. For example, as shown in FIG. 2, attribute information of a text file A which is contained by both a client device A and a client device B may be stored in a server 10 of the first storage section 2011. Device information (e.g., IP address and MAC address) of the client device A and the client device B is defined as the location information of the text file A, and is stored in the server 10 as well as other attribute information (e.g., data name and data size) of the text file A.

Any client device presented in the network 200 can send a request message to the intermediate device 11 for requesting to access the sharing data. In one embodiment, the client device which requests the sharing data is defined as a first client device. The other client devices that contain the desired or target sharing data are defined as second devices.

The request unit 111 searches the web server group 20 for the second client devices that contain the target sharing data, when the request message requesting to access the target sharing data is received from the first client device. In the embodiment, the request unit 111 first determines which of the first storage network 201 and the second storage network 202 is configured for storing the attribute information of the target sharing data according to a type of the first client device, such as whether a user of the first client device is a public or a private user. Then, the request unit 111 determines a storage section of the first storage network 201 or the second storage network 202 that is used to store the attribute information of the target sharing data according to a type of the target sharing data. Additionally, the request unit 111 searches the determined storage section for the second client devices that contain the target sharing data.

The connection unit 112 establishes one or more peer to peer connections between the first client device and one or more of the second client devices that contain the target sharing data through the network 200, and downloads the target sharing data from the one or more second client devices to the first client device. In one embodiment, if a connection between the first client device and N (N>1) second client devices is established, the connection unit 112 divides a task of downloading the target sharing data into N sub-tasks, and allocates each of the sub-tasks to a second client device, so as to improve a speed of downloading the target sharing data.

The information update unit 113 updates attribute information of the target sharing data stored in the web server group 20 with device information of the first client device, after the target sharing data is downloaded to the first client device. Thus, other client devices can share the target sharing data now held in the first client device. In the embodiment, the information update unit 113 updates the attribute information of the target sharing data by adding the device information of the first client device to the location information of the target sharing data.

The data synchronization unit 114 records popular sharing data that is downloaded more than a predetermined number of times (e.g., ten times) within a predetermined time period (e.g., one day), and synchronizes the popular sharing data from one or more client devices that contain the popular sharing data to the intermediate device 11. Then, the data synchronization unit 114 defines the intermediate device 11 as a new client device and updates attribute information of the popular sharing data stored in the web server group 20 with device information of the intermediate device 11. Thus, even if the client devices that contain the popular sharing data are not presented in the network 200, other client devices can access the popular sharing data through the intermediate device 11. Additionally, the data synchronization unit 114 regularly clears the popular sharing data that have been synchronized to the intermediate device 11 for a preset time period at regular intervals, such as every one or two weeks, so that the intermediate device 11 always has enough storage space to store other popular sharing data.

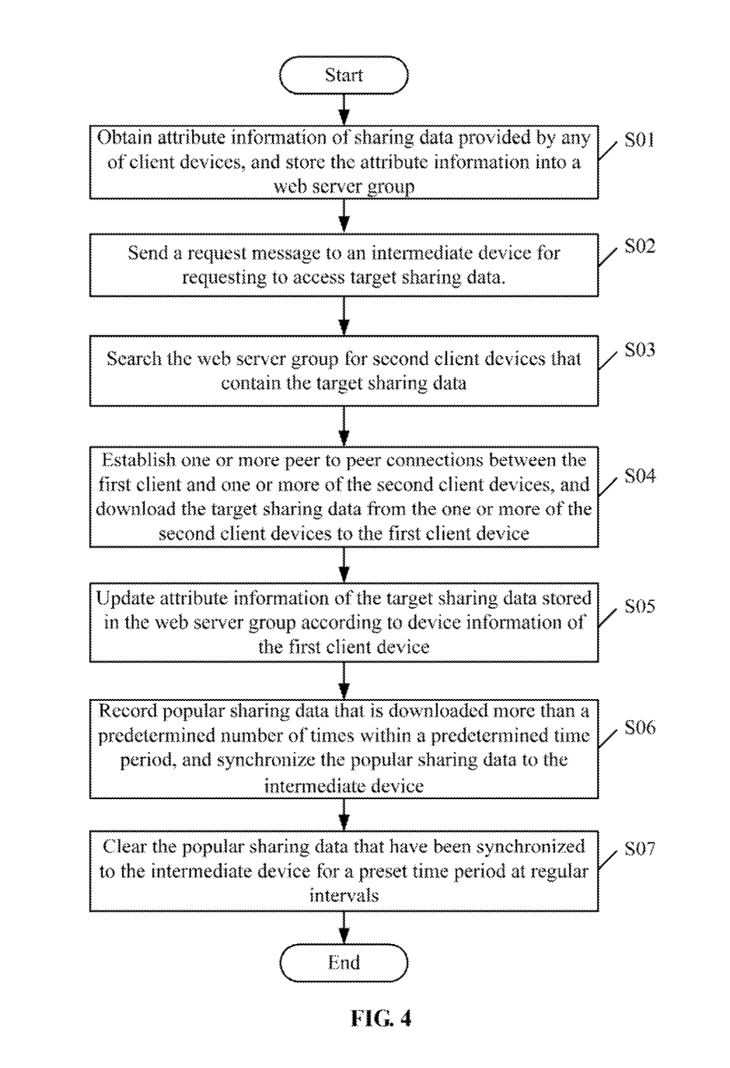

FIG. 4 is a flowchart of one embodiment of a data storage and sharing method using the cloud storage system of FIG. 1. Depending on the embodiment, additional steps may be added, others removed, and the ordering of the steps may be changed.

In step S01, the obtaining unit 110 obtains attribute information of sharing data provided by any of the client devices, and stores the obtained attribute information into the server 10 of the web server group 20. The sharing data refers to data stored in one or more of the client devices, and can be accessed/shared by other client devices through the network 200. The attribute information may include a data name, a data size, and a version of the sharing data, and location information indicating where the sharing data is stored, such as an IP address and/or a MAC address of one or more of client devices that contain the sharing data.

In step S02, a first client device sends a request message to the intermediate device 11 for requesting access to the target sharing data.

In step S03, the request unit 111 searches the web server group 20 for second client devices that contain the target sharing data.

In step S04, the connection unit 112 establishes one or more peer to peer connections between the first client device and one or more of the second client devices that contain the target sharing data through the network 200, and downloads the target sharing data from the one or more of the second client devices to the first client device.

In step S05, the information update unit 113 updates attribute information of the target sharing data stored in the web server group 20 according to device information of the additional first client device which now holds the target sharing data.

In step S06, the data synchronization unit 114 records popular sharing data that is downloaded more than a predetermined number of times within a predetermined time period, synchronizes the popular sharing data from one or more client devices that contain the popular sharing data to the intermediate device 11. Then, the data synchronization unit 114 defines the intermediate device 11 as a new client device and updates attribute information of the popular sharing data according to device information of the intermediate device 11.

In step S07, the data synchronization unit 114 clears the popular sharing data that have been synchronized to the intermediate device 11 for a preset time period at regular intervals.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud storage system, the system comprising:
at least one server; and
an intermediate device that communicates with the at least one server, wherein a plurality of client devices communicating with the intermediate device through a network, the intermediate device comprising:
an obtaining unit that obtains attribute information of various sharing data provided by any of the client devices, and stores the obtained attribute information into the at least one server;
a request unit that receives a request message from a first client device that requests to access target sharing data, and searches the at least one server for second client devices which contain the target sharing data the first client device requested; and
a connection unit that establishes one or more peer to peer connection between the first client device and one or more of the second client devices that contain the target sharing data through the network, and downloads the target sharing data from the one or more of the second client devices to the first client device.

2. The cloud storage system according to claim 1, wherein the attribute information comprises a data name, a data size, and a version of the sharing data, and location information indicating where the sharing data is stored, the location information comprising an IP address and/or a MAC address of at least one of the client devices that contain the sharing data.

3. The cloud storage system according to claim 2, wherein the intermediate device further comprises:
an information update unit that updates attribute information of the target sharing data stored in the at least one server according to device information of the first client device after the target sharing data is downloaded to the first client device, the device information comprising an IP address and/or a Mac address of the first client device.

4. The cloud storage system according to claim 1, wherein the intermediate device further comprises:
a data synchronization unit that records popular sharing data that is downloaded more than a predetermined number of times within a predetermined time period, synchronizes the popular sharing data from one or more of the client devices that contain the popular sharing data to the intermediate device, and defines the intermediate device as a new client device and updates attribute information of the popular sharing data according to device information of the intermediate device.

5. The cloud storage system according to claim 4, wherein the data synchronization unit further regularly clears the popular sharing data that have been synchronized to the intermediate device for a preset time period at regular intervals.

6. The cloud storage system according to claim 1, wherein the connection unit further divides a task of downloading the target sharing data into N sub-tasks when connections between the first client device and N second client devices are established, and allocates each of the sub-tasks to a second client device, where N>1.

7. The cloud storage system according to claim 1, wherein the system comprises a plurality of servers that forms a web server group, the web server group being divided into a first storage network and a second storage network, and each of the first storage network and the second storage network being configured for storing attribute information of the sharing data provided by different types of the client devices.

8. The cloud storage system according to claim 7, wherein each of the first storage network and the second storage network is divided into multiple storage sections, and each of the storage sections is configured for storing attribute information of different types of the sharing data.

9. The cloud storage system according to claim 8, wherein the second client devices which contain the target sharing data are searched by:
determining which of the first storage network and the second storage network is configured for storing the attribute information of the target sharing data according to a type of the first client device;
determining a storage section which is used to store the attribute information of the target sharing data from the first storage network or the second storage network according to a type of the target sharing data; and
searching the determined storage section for the second client devices that contain the target sharing data.

10. A computerized data storage and sharing method based on a cloud storage system, the system comprising at least one server, and an intermediate device that communicates with the at least one server, wherein a plurality of client devices communicates with the intermediate device through a network, the method comprising:
obtaining attribute information of various sharing data provided by any of the client devices, and storing the obtained attribute information into the at least one server;
receiving a request message from a first client device that requests to access target sharing data;
searching the at least one server for second client devices which contain the target sharing data that the first client device requested when the request message is received; and
establishing one or more peer to peer connections between the first client device and one or more of the second client devices that contain the target sharing data through the network, and downloading the target sharing data from the one or more of the second client devices to the first client device.

11. The method according to claim 10, wherein the attribute information comprises a data name, a data size, and a version of the sharing data, and location information indicating where the sharing data is stored, the location information comprising an IP address and/or a Mac address of at least one of the client devices that contain the sharing data.

12. The method according to claim 11, further comprising:
updating attribute information of the target sharing data stored in the at least one server according to device information of the first client device after the target sharing data is downloaded to the first client device, the device information comprising an IP address and/or a MAC address of the first client device.

13. The method according to claim 10, further comprising:
recording popular sharing data that is downloaded more than a predetermined number of times within a predetermined time period;
synchronizing the popular sharing data from one or more of the client devices that contain the popular sharing data to the intermediate device; and
defining the intermediate device as a new client device and updating attribute information of the popular sharing data according to device information of the intermediate device.

14. The method according to claim 13, further comprising:
clearing the popular sharing data that have been synchronized to the intermediate device for a preset time period at regular intervals.

15. The method according to claim 10, wherein the establishing step comprises:
dividing a task of downloading the target sharing data into N sub-tasks when connections between the first client device and N second client devices are established, and allocating each of the sub-tasks to a second client device, where N>1.

16. The method according to claim 10, wherein the system comprises a plurality of servers that forms a web server group, the web server group being divided into a first storage network and a second storage network, and each of the first storage network and the second storage network being configured for storing attribute information of the sharing data provided by different types of the client devices.

17. The method according to claim 16, wherein each of the first storage network and the second storage network is divided into multiple storage sections, and each of the storage sections is configured for storing attribute information of different types of sharing data.

18. The method according to claim 17, wherein the searching step comprises:
determining which of the first storage network and the second storage network that is configured for storing the attribute information of the target sharing data according to a type of the first client device;
determining a storage section which is used to store the attribute information of the target sharing data from the first storage network or the second storage network according to a type of the target sharing data; and
searching the determined storage section for the second client devices that contain the target sharing data.
